(19) United States
(12) Patent Application Publication
(10) Pub. No.: US 2008/0062269 A1
(43) Pub. Date: Mar. 13, 2008

(54) UNDERWATER VISUAL INSPECTION

(75) Inventor: Gary OMER, Reepham (GB)

Correspondence Address: BURR & BROWN, PO BOX 7068, SYRACUSE, NY, 13261-7068, US

(73) Assignee: U.W.G. Limited, Norwich (GB)

(21) Appl. No.: 11/851,888

(22) Filed: Sep. 7, 2007

(30) Foreign Application Priority Data
Sep. 12, 2006 (GB) 0618022.8

(51) Int. Cl. H04N 5/232

(52) U.S. Cl. 348/211.11; 348/E05.042

(57) ABSTRACT

The present invention relates to a system and a method for underwater visual inspection, and in particular to a system and method for inspecting the underwater condition and installation or deployment of jack-up rigs. The inspection system comprises an underwater extending elongate member of an underwater structure, a camera system movably affixed to said elongate member, said camera system including an underwater camera. The inspection system includes motive means for moving said camera along the length of said elongate member between relatively shallower and relatively deeper portions of said elongate member.

### BACKGROUND

a. Field of the Invention

The present invention relates to a system and a method for underwater visual inspection, and in particular to a system and method for inspecting the underwater condition and installation or deployment of jack-up rigs.

b. Related Art

A common type of oil rig is referred to as a jack-up rig, in which the drilling or production facility is supported on three or more extendible legs. The rig is towed to its location with the legs retracted and then the legs are extended down to the seafloor. The facility can then be jacked up on the legs to lift it above the sea surface, to reduce the risk of rig damage from waves. Each of the extendible legs has a foundation structure on the end to provide a stable footing for the rig, commonly referred to as a spudcan. Spudcans are generally conical in section, over 15 m in diameter and may penetrate the seabed in excess of 30 m.

At the initial stage of penetration into the seabed, a cavity is formed above the spudcan as it moves into the seabed, forming a raised ring of seabed material around the periphery of the spudcan. The lateral extent of visible distortion is normally confined to within a diameter of about 1.5 times the diameter of the spudcan.

When the jack-up rig is no longer needed at that location, the extendible legs are raised, after which the rig can be moved to a new location.

When installing a jack-up rig it is critical for each spudcan to be located appropriately, for example such that it is not landed on a pipeline or other sea floor structure. It is also necessary to ensure that the spudcan either locates exactly within a previous spudcan footprint or misses entirely the footprint that may have been left by the spudcans of a previously installed jack-up rig. This is because a spudcan will tend to slip laterally into the depression left by a previous spudcan. Unless there is a close match with the location of the spudcan with the previous footprint, there is a serious risk that any lateral movement of a spudcan, without the corresponding movement of all the other spudcans already seated on the seafloor, will bend and damage the legs which could even lead to the loss of the rig.

Conventionally, the correct positioning of a spudcan is achieved by the use of a remotely operated vehicle (ROV) that carries a camera system to survey the area of the seafloor that the spudcan is to be installed into and to provide feedback as each leg is jacked down. Such ROV's are also used to survey corrosion in the “splash zone” of the rig, which is the area between the water level and the base of the rig legs. This can normally only be done in the best weather conditions in order to minimise the potential for damage to the ROV and rig legs. Furthermore, whether an ROV is being used for corrosion surveys or spudcan location work, ROV's can typically only be lowered into the water, and be reliably controlled, in comparatively low current and wave conditions.

It is an object of the invention to provide a more convenient system and method for inspection of an underwater structure.

### SUMMARY OF THE INVENTION

According to the invention, there is provided a method of locating the underwater footings for a support leg of a jack-up rig, using a camera-based inspection system that includes a camera system movably affixed to said support leg, the method comprising the steps of:

moving said camera system between relatively shallower and relatively deeper portions of said support leg; and or rail affixed to the elongate member. The carriage may include rollers or wheels that engage with the guide.

For reasons of reliability, the motive means may include a motor that is separate from the camera system. Preferably, the motor is above water. The motor may be connected to the camera system via a cable that in use controls the underwater depth of the camera system. The camera system may then sink under the action of gravity when the cable is let out. Alternatively, there may be a second cable which loops underneath the camera system to pull the camera system down as the first cable is let out.

The camera system may include at least one actuator for controlling the orientation of the field of view of the underwater camera. In a preferred embodiment of the invention, the actuator includes an articulated arm on a distal end of which the underwater camera is positioned.

In order to protect the camera system when not in use, the or each articulated arm may be arranged to fold up against the elongate member when not in use.

Also according to the invention, there is provided a method of inspection of an underwater structure, said structure having an underwater extending elongate member and a camera system movably affixed to said elongate member, the method comprising the steps of:

moving said camera system between relatively shallower and relatively deeper portions of said elongate member; and

using an underwater camera of said camera system to inspect portions of the underwater structure and/or the floor of a body of water beneath or around the underwater structure.

### BRIEF DESCRIPTION OF THE DRAWINGS

The invention will now be further described, by way of example only, with reference to the accompanying drawings, in which:

FIG. 1 is a perspective drawing of a jack up rig have three jack-up support legs, one of which is shown with a spudcan footing engaged in the soft floor of a body of water;

FIG. 2 is a plan view of one of the legs of FIG. 1, showing how an inspection system according to a preferred embodiment of the invention is used to check the underneath and around spudcan prior to engaging the spudcan in the floor of the body of water;

FIG. 3 is schematic cross-section view along line III-III of FIG. 2, through an elongate member which forms part of the support leg, showing from above part of the below water components of the inspection system; and

FIG. 4 is a schematic diagram showing above water components of the inspection system.

### DETAILED DESCRIPTION

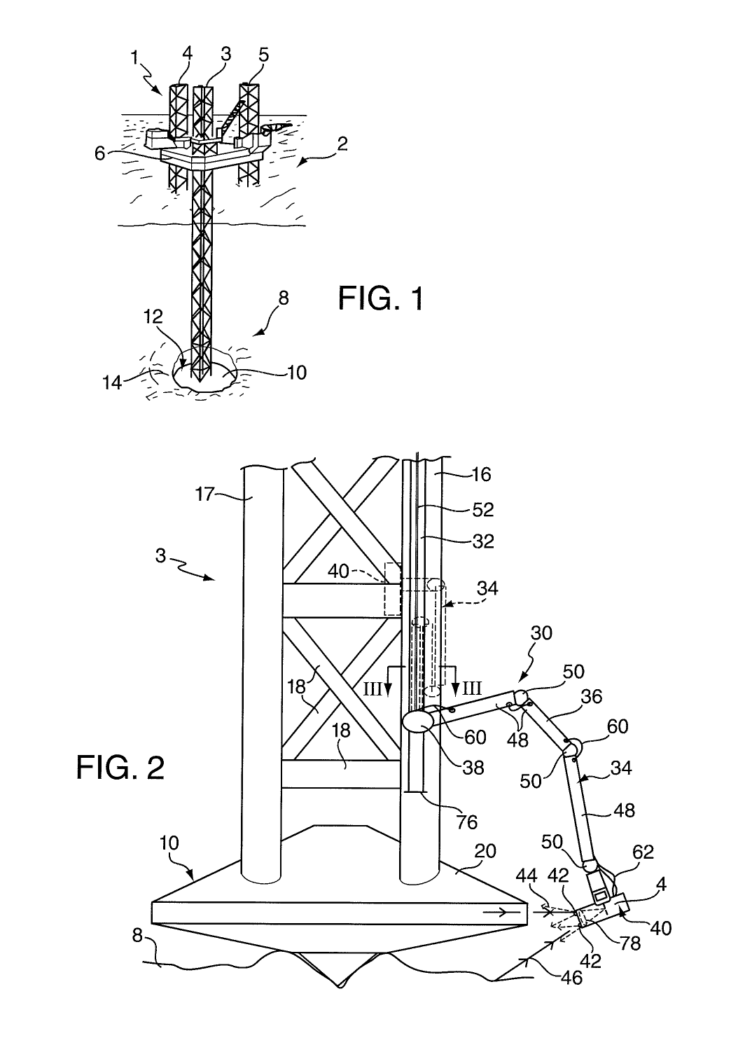

FIG. 1 shows a jack-up rig 1 positioned at a desired location in a body of water, which is here the sea 2. The jack-up rig 1 has three similar jack-up legs 3, 4, 5, which together support the weight of a platform 6 of the jack-up rig. One of the legs 3 is shown engaged with the seafloor 8, where a spudcan footing 10 has punched a hole 12 in the seafloor, which will usually be mud or sand. The hole is surrounded by a raised ring 14 of material displaced from the hole 12.

Reference is now made to FIG. 2, which shows in detail the lower end of the leg 3 and spudcan 10. The leg 3 is formed from four similar elongate members, two of which 16, 17 are visible in the side elevation view of FIG. 2. The elongate members 16, 17 extend parallel to each other vertically downwards from the platform 6, and are braced apart by diagonal and transverse bracing members 18.

The elongate members are fixed to an upper conical surface 20 of the spudcan 10. Lower conical surfaces 21, 22 of the spudcan are designed to insert without lateral shifting in the seafloor 2. In this example, the spudcan is about 14 m in diameter, and about 7 m high. In use, the spudcan can penetrate up to about 30 m into the seafloor depending on the softness of the seafloor material.

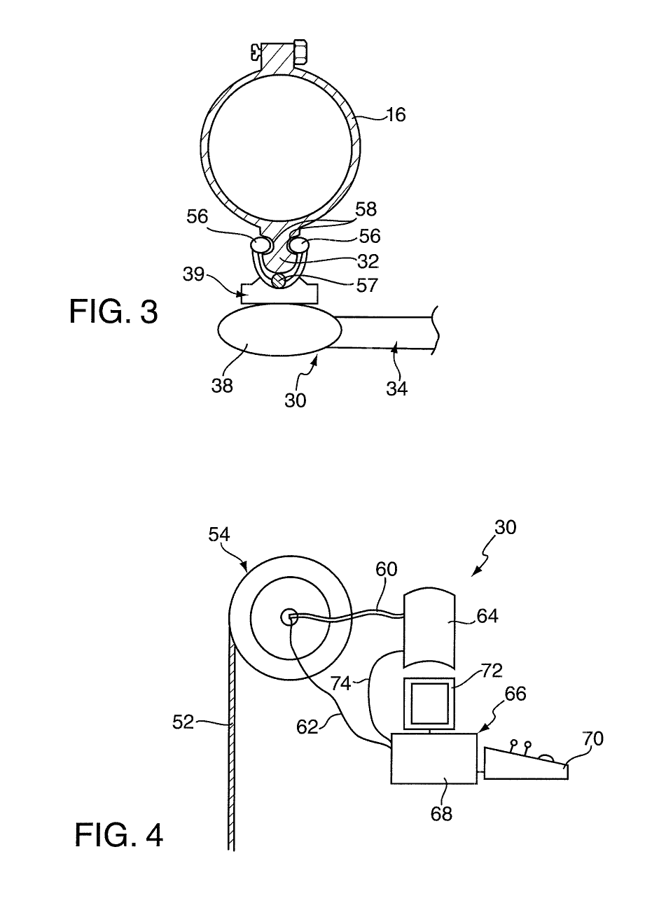

With reference now also to FIGS. 3 and 4, one of the elongate members 16 is used to support the underwater components of an inspection system 30, namely a vertically extending guide or track 32 fixed externally on the elongate member 16, and an underwater actuator and camera system 34 which slides along the track 32.

The actuator and camera system 34 includes a multiple-jointed arm 36, fixed at one end to a rotational pivot 38 to a carriage 39 which rides along the track 32, and at the other end to an underwater video camera system 40 that includes a video camera 41 and white LED light sources 42 that together project a cone of illumination 44 to illuminate a field of view 46 of the camera system.

The pivot 38 provides rotational motion for the arm about a horizontal axis over a range of about ±90° from the horizontal. The length of the arm 36, the number of segments 48 and the number of articulated joints 50 allow a full freedom of movement for the camera system 40 so that this can view the seafloor 8 all around the spudcan 10 and also beneath the spudcan 10 when this is to be engaged with the seafloor 10 when the rig is being jacked up.

The carriage 39 may be pulled upwards along the track 32 by means of a cable bundle 52 which includes a steel rope 57 that is affixed at one end to the carriage 39. The cable bundle 52 is reeled in or out by a winch mechanism 54 situated on the platform 6. When the winch 54 is used to let the cable 52 bundle out, the carriage 39 moves downwards under the weight of the underwater components of the inspection system 30. To ensure free and easy movement, the carriage 39

using an underwater camera of said camera system to inspect portions of the underwater structure of the jack-up rig and/or the floor of a body of water beneath or around the footings of the jack-up rig;

in response to a satisfactory inspection, lowering said support leg to engage the footings with the floor of a body of water.

Preferably, the field of view of the underwater camera can be controlled by an operator of the inspection system to view the floor of the body of water around and/or underneath the footing.

Also according to the invention, there is provided a jack-up rig, comprising an underwater structure including jack-up support legs and an inspection system for inspecting the underwater structure, the inspection system comprising a camera system movably mounted on a support leg, the camera system including an underwater camera, the system including motive means for moving the camera along the length of the support leg between relatively shallower and relatively deeper portions of the leg.

The support leg will usually include at a bottom end thereof a footing for distributing the weight of the jack-up rig on the floor of a body of water.

The camera system may then be arranged so that it can be used to inspect the location of the footing when the jack-up leg is to be lowered to engage the footing with the floor of a body of water.

The camera system is preferably slideably affixed to said elongate member. For example, the system may slide by means of low friction pads, rollers or wheels.

The elongate member preferably comprises a guide for guiding the camera system between relatively shallower and relatively deeper portions of said elongate member. The camera system may then additionally comprise means, for example a carriage, movably connected with the guide. The guide may be an elongate track includes a pair of wheels 56 that engage in grooves 58 in opposite sides of the track 32.

The cable bundle includes hydraulic lines 60 for supplying hydraulic power to hydraulic actuators (not shown) within the arm segments 48. The cable bundle 52 also includes electrical lines 62 for supplying electrical power to the camera system 40.

FIG. 4 shows the above water components of the inspection system 30, which will normally be located on the platform 6 of the jack-up rig 1. Hydraulic and electrical lines 60, 62 are connected through from the winch mechanism 54 respectively to a hydraulic power source 64 and to an electronic control system 66 that includes a computer 68, a keyboard and joy stick control panel 70 and a display 72. A control line 74 also connects the hydraulic power source 64 and the computer 68 to provide control of the hydraulic actuators.

The track 32 has a stop 76 at its lower end which limits the lower extent of movement for the carriage 39, and extends nearly to the top of the leg 3 so that the underwater components of the inspection system 30 can be removed from the water, or used near the water surface to inspect for corrosion in the splash zone.

When not in use, the arm segments 48 can be folded against the elongate member 16 to provide protection for the arm 36 and camera system 40, as shown in phantom outline in FIG. 2. In this stowed orientation, the camera system 40′ can be oriented to angle a lens aperture 78 downwards so that silt does not block or cloud the aperture 78.

It should be noted that if desired, each leg 3, 4, 5 could have more than one inspection system on different elongate members 16, 17. This may provide additional redundancy should any one inspection system be inoperative, and would allow different portions of the underwater structure or seafloor to be inspected at the same time.

When a leg 3, 4, 5 and spudcan 10 are to be placed on the seafloor 8, the inspection system 30 can be used to inspect the seafloor for any hazards or obstacles. The spudcan can then be located on a fresh area of seafloor or alternatively located accurately into an existing spudcan depression.

The invention avoids many of the costs of using a remotely operated vehicle (ROV) system. ROV's are part of a mechanically and electrically complex system and are prone to breakdowns. ROV's can only survey one leg at a time, while an inspection system according to the invention, because of its relative economy, can be fitted to each leg of the rig. The invention also avoids the inherent risk of damaging a leg or other underwater structure in a collision with the ROV.

The skilled person will appreciate that although the invention has been described specifically in relation to its use with a jack-up rig, the invention is applicable also with other structures such as offshore wind turbines, oil or gas production platforms or any other facility having an underwater structure, and is particularly useful when used to help put in place any structure with underwater foundations.

The invention therefore provides a convenient system and method for inspection of an underwater structure.

1. A method of locating the underwater footings for a support leg of a jack-up rig, using a camera-based inspection system that includes a camera system movably affixed to said support leg, the method comprising the steps of:
moving said camera system between relatively shallower and relatively deeper portions of said support leg; and
using an underwater camera of said camera system to inspect portions of the underwater structure of the jack-up rig and/or the floor of a body of water beneath or around the footings of the jack-up rig;
in response to a satisfactory inspection, lowering said support leg to engage the footings with the floor of a body of water.

2. A method as claimed in claim 1, wherein the rig has a plurality of legs, and a camera system is movably affixed to each leg.

3. A method as claimed in claim 1, wherein more than one camera system is movably affixed to each leg.

4. A jack-up rig, comprising an underwater structure including jack-up support legs and an inspection system for inspecting the underwater structure, the inspection system comprising a camera system movably mounted on a support leg, the camera system including an underwater camera, the system including motive means for moving the camera along the length of the support leg between relatively shallower and relatively deeper portions of the leg.

5. A jack-up rig as claimed in claim 4, in which said support leg includes at a bottom end thereof a footing for distributing the weight of the jack-up rig on the floor of a body of water.

6. A jack-up rig as claimed in claim 5, in which the camera system is arranged for inspecting the location of the footing when the jack-up leg is to be lowered to engage the footing with the floor of a body of water.

7. A jack-up rig as claimed in claim 6, in which the field of view of the underwater camera can be controlled to view the floor of the body of water around and/or underneath the footing.

8. A jack-up rig as claimed in claim 4, wherein the leg carries a guide for guiding the camera system between relatively shallower and relatively deeper portions of the leg, the camera system additionally comprising means movably connected with the guide.

9. A jack-up rig as claimed in claim 8, in which the guide is an elongate track or rail affixed to the leg.

10. A jack-up rig as claimed in any claim 9, in which the carriage includes rollers or wheels that engage with said guide.

11. A jack-up rig as claimed in claim 4, in which the motive means includes a motor that is separate from the camera system.

12. A jack-up rig as claimed in claim 11, in which the motor is above water.

13. A jack-up rig as claimed in claim 12, in which the motor is connected to the camera system via a cable that in use controls the underwater depth of the camera system.

14. A jack-up rig as claimed in claim 4, in which the camera system includes at least one actuator for controlling the orientation of the field of view of the camera.

15. A jack-up rig as claimed in claim 14, in which the actuator includes an articulated arm on a distal end of which the underwater camera is positioned.

16. A jack-up rig as claimed in claim 15, in which the or each articulated arm is arranged to fold up against the elongate member when not in use.

17. A jack-up rig as claimed in claim 16, in which the actuator is hydraulically powered.

18. A jack-up rig as claimed in claim 17, in which the system includes a hydraulic power source, said power source being separate from the camera system.

19. A jack-up rig as claimed in claim 18, in which the hydraulic power source is connected to the actuator via at least one hydraulic line.

20. A jack-up rig as claimed in claim 19, in which the hydraulic power source is situated above water.

21. A method of inspection of an underwater structure, said structure having an underwater extending elongate member and a camera system movably affixed to said elongate member, the method comprising the steps of:
moving said camera system between relatively shallower and relatively deeper portions of said elongate member; and
using an underwater camera of said camera system to inspect portions of the underwater structure and/or the floor of a body of water beneath or around the underwater structure.
